(19) United States
(12) Patent Application Publication
(10) Pub. No.: US 2013/0010357 A1
(43) Pub. Date: Jan. 10, 2013

(54) DISPLAY DEVICE

(75) Inventors: Izushi Kobayashi, Tokyo (JP); Hiroyuki Yanagisawa, Kanagawa (JP); Hiroki Kikuchi, Kanagawa (JP)

(73) Assignee: Sony Corporation, Tokyo (JP)

(21) Appl. No.: 13/527,847

(22) Filed: Jun. 20, 2012

(30) Foreign Application Priority Data
Jul. 4, 2011 (JP) 2011-147909

(51) Int. Cl. G02B 27/22

(52) U.S. Cl. 359/463

(57) ABSTRACT

Provided is a display device including a housing whose side surface has one or more slits, and a display that is mounted in the housing and has a substantially arc shape, wherein an image displayed on the display is visually recognized beyond the slit when the housing rotates, and a curvature of the display having the substantially arc shape is formed so that stray light resulting from a specular reflection does not occur.

### BACKGROUND

The present disclosure relates to a display device, for example, to a display device in which a display is configured in an arc-shaped display by a large number of light emitting diodes (LEDs).

In the related art, there are three dimensional display technologies in which a stereoscopic image is displayed on a flat display used in a television receiver or the like. For example, in the three-dimensional display technologies, there is a technology in which parallax of left and right eyes of a human watching a display is used. Specifically, for example, stereoscopic vision may be realized such that only an image for a left eye is watched by the left eye and only an image for a right eye is watched by the right eye by alternately displaying the image for the left eye and the image for the right eye on a flat display and using a polarization filter and the like

In contrast, many omnidirectional stereoscopic image display devices have been proposed in which a plurality of images of different perspectives, which are captured from a plurality of perspectives provided on the circumference around a subject (an object to be displayed) (or, are generated assuming a state in which the object is seen by computer graphics from all directions), are used, and a display may be performed such that the object may be stereoscopically visually recognized when seen from any arbitrary direction among all of the directions (for example, refer to Japanese Laid-Open Patent Publication Nos. 2004-177709 and 2005-114771).

Such an omnidirectional stereoscopic image display device has a configuration in which a housing is formed in a cylindrical shape, a display having an arc shape configured by disposing a large number of small light emitting diodes (LEDs) is provided in the inside of the housing, and slits are disposed on the side surface of the housing so that images of the display may be visually recognized from the outside of the housing through the slits. Then, the housing is rotated at high speed by a motor, and thus, when a side surface of the housing having the cylindrical shape is seen from a certain direction by a user, the object to be displayed on the display may be stereoscopically visually recognized.

### SUMMARY

As described above, in an omnidirectional stereoscopic image display device, since a display is formed in an arc shape, light radiated from a certain position of a display as an image can be subjected to specular reflection at another position on the display, and the reflected light visually recognized via a slit by a user can be obtained (hereinafter referred to as “stray light resulting from the specular reflection”). In this case, since brightness near the reflected position appears brighter than original brightness, contrast in an image may be degraded.

According to an embodiment of the present disclosure, it is possible to suppress degradation of contrast caused by stray light resulting from specular reflection which occurs at a display having an arc shape.

According to an embodiment of the disclosure, a display device may include a housing whose side surface has one or more slits, and a display that is mounted in the housing and has a substantially arc shape, wherein an image displayed on the display is visually recognized beyond the slit when the housing rotates, and the display having the substantially arc shape has a curvature at which stray light resulting from specular reflection does not occur.

When a spot at which light emitted from an arbitrary spot s on the display is subjected to specular reflection is defined as a, a center of the arc of the display is defined as b, a center of the slit is defined as c, an angle formed by spots s, a, and b is defined as α, and an angle formed by spots b, a and c is β, α>β can always be satisfied.

According to an embodiment of the present disclosure, a display device may further include a support member that supports the display, wherein a reflection reduction sheet may be attached to the support member to reduce reflection of light, or a coating material may be coated thereon.

The housing may have a cylindrical shape.

The display having the substantially arc shape may be configured to be same in number as the slits.

According to an embodiment of the present disclosure, a curvature of a display having a substantially arc shape is formed so that stray light resulting from a specular reflection does not occur.

According to an embodiment of the present disclosure, it is possible to suppress degradation of contrast caused by stray light resulting from specular reflection which occurs at a display having an arc shape.

### BRIEF DESCRIPTION OF THE DRAWINGS

FIG. 1 is an appearance view illustrating an omnidirectional stereoscopic image display device according to an embodiment of the present disclosure;

FIG. 2 is a horizontal sectional view illustrating an omnidirectional stereoscopic image display device;

FIG. 3 is a view illustrating a display of curvature R= 1/18 mm;

FIG. 4 is a view illustrating a display of curvature R= 1/28 mm;

FIG. 5 is a view illustrating a display of curvature R= 1/25 mm;

FIG. 6 is a view for explaining an optimal curvature of a display; and

FIG. 7 is a view showing a case in which a support member is provided on a display.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Hereinafter, preferred embodiments of the present disclosure will be described in detail with reference to the appended drawings.

### 1. Embodiment

[Configuration Example of Omnidirectional Stereoscopic Image Display Device]

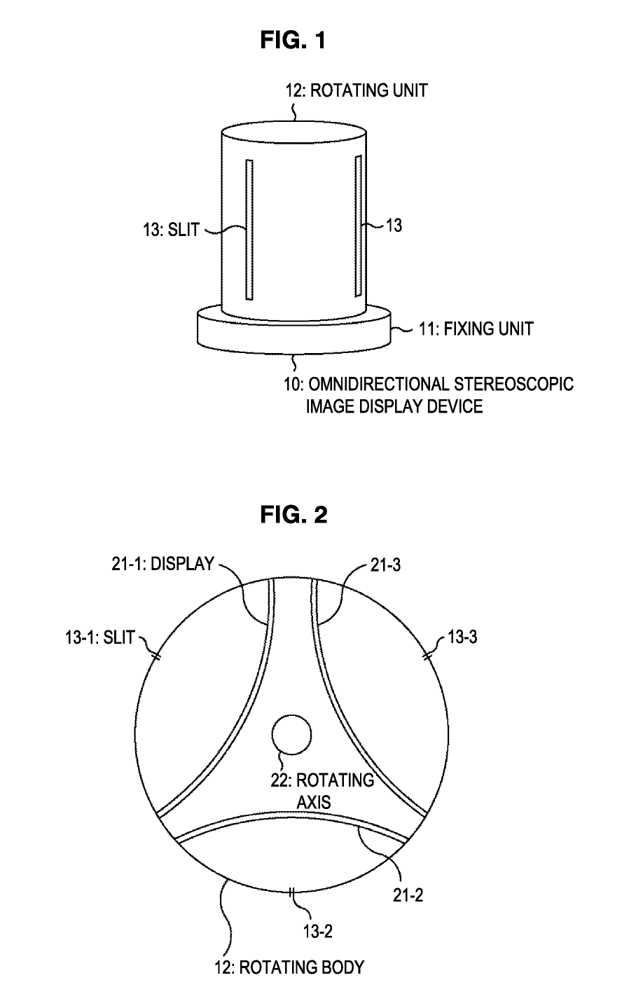

FIG. 1 is an appearance view illustrating an omnidirectional stereoscopic image display device according to an embodiment of the present disclosure. The omnidirectional stereoscopic image display device 10 includes a fixing unit 11 that is a pedestal and a rotating unit 12 that has a cylindrical shape and rotates at high speed.

In the omnidirectional stereoscopic image display device 10, an object that may be stereoscopically visible to a user watching the rotating unit 12 that rotates at high speed from any direction appears (is displayed) on an inside center of the rotating unit 12.

The fixing unit 11 has a sufficient weight that the omnidirectional stereoscopic image display device 10 does not move even when the rotating unit 12 rotates at high speed. A plurality of slits 13 are provided on the cylindrical side of the rotating unit 12, and displays 21 are provided on the inside of the rotating unit 12 in the same numbers as the slits 13. In this embodiment, three of the slits 13 and displays 21 are provided. However, the numbers of the slits 13 and the displays 21 are not limited to three, but, for example, may be more two or four or more.

FIG. 2 shows a horizontal cross-section of a rotating unit 12.

Displays 21-1 to 21-3 formed on an arc around the rotating axis 22 are provided on the inside of the rotating unit 12. A large number of small LEDs are disposed on a display surface of each display 21. Images of the displays 21-i (i=1, 2, 3) are visible from an outside of the rotating unit 12 through the slits 13-i.

Additionally, if the curvature R (=1/r (r is a radius of the arc)) of the display 21 formed on the arc shape is large, because stray light resulting from specular reflection occurs, it is necessary to form the display 21 at the curvature R in which the stray light does not occur.

[Curvature of Display]

Hereinafter, the curvature R of the display will be considered.

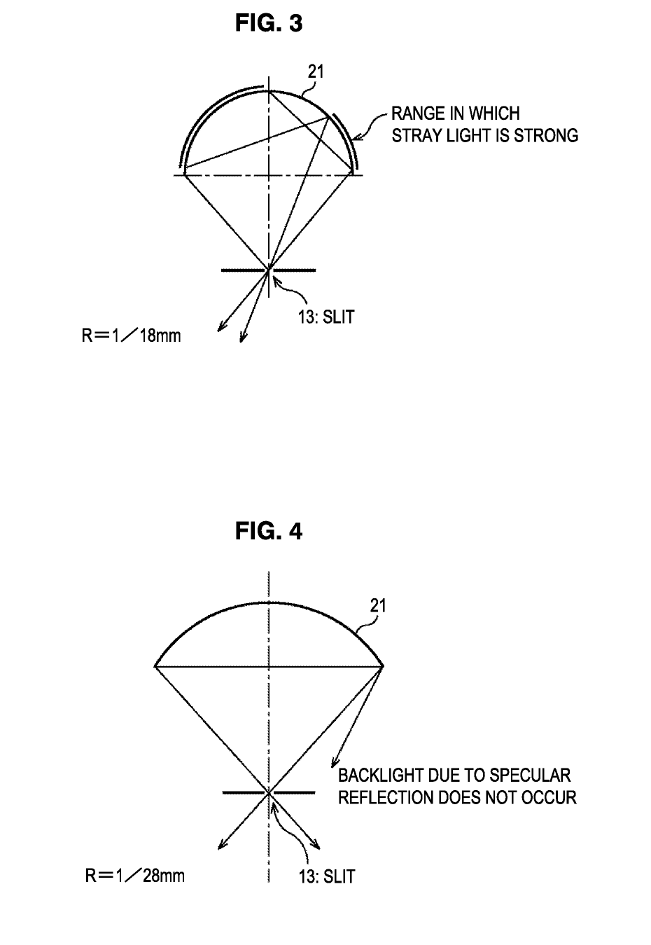

FIG. 3 shows a case in which the curvature R of the display 21 is R= 1/18 mm. In this case, because the stray light resulting from the specular reflection occurs as shown in FIG. 3, a contrast of the end portion of the display 21 will be decreased.

Next, FIG. 4 shows a case in which the curvature R of the display 21 is R= 1/28 mm. In this case, although the specular reflection occurs as shown in FIG. 4, because the reflected light is not visually recognized from the slit 13, decrease in contrast of the end portion of the display 21 is suppressed.

As is apparent from FIGS. 3 and 4, the optimal curvature R is suggested between R= 1/18 mm and R= 1/28 mm, and as a result of changing the curvature R of the display 21 on the basis of this suggestion, it has been confirmed that the stray light resulting from the specular reflection does not occur in the display 21 having the curvature R= 1/25 mm or less.

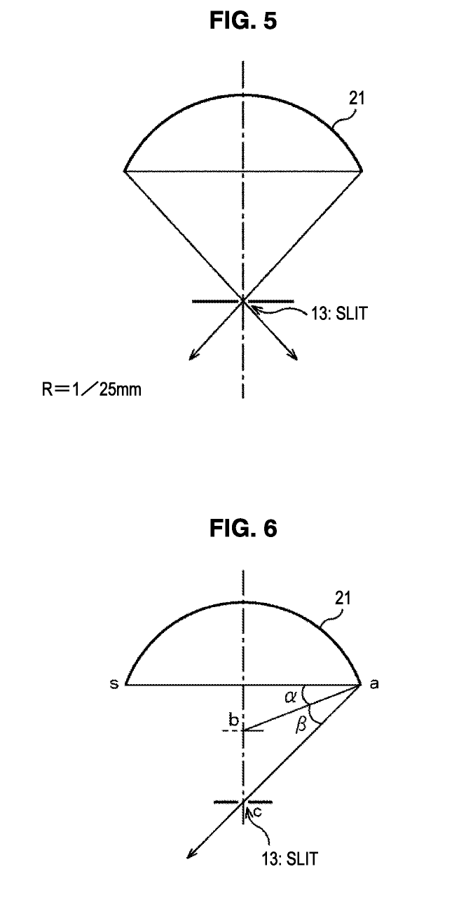

FIG. 5 shows a case in which the curvature R of the display 21 is R= 1/25 mm. In this case, because the reflected light due to the occurring specular reflection is not visually recognized from the slit 13, decrease in contrast of the display 21 is suppressed.

[Generalization of Ideal Curvature of Display]

FIG. 6 shows a generalization of an ideal curvature of the display 21. Assuming that a spot at which light emitted from an arbitrary spot s on the display 21 is subjected to specular reflection on the display 21 is defined as a, the center of the arc is defined as b, the center of the slit 13 is defined as c, an angle formed by spots s, a, and b is defined as α and an angle formed by spots b, a and c is defined as β, a condition under which the stray light resulting from the specular reflection does not occur is that α>β is always satisfied.

The case of FIG. 3 described above (R= 1/18 mm) is not the ideal curvature because α>β is not always satisfied and the condition is thus not satisfied. The case of FIG. 4 (R= 1/28 mm) satisfies the condition because α>β is always satisfied. Thus, the curvature may be called an ideal curvature. The case of FIG. 5 (R= 1/25 mm) satisfies the condition because α>β is always satisfied. Thus, the curvature may be called an ideal minimum curvature.

[Stray Light Resulting from Specular Reflection Other than Display]

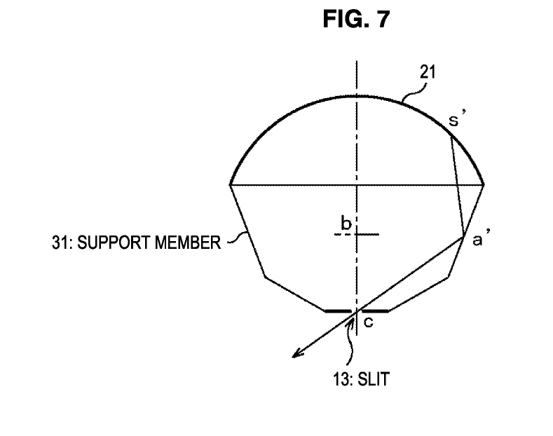

FIG. 7 shows a case in which a support member 31 to support an arc shape is provided on a display 21 of the arc shape.

As shown in FIG. 7, when the support member 31 is provided between the display 21 and the slit 13, the reflected light, which is radiated from the display 21 and reflected onto the support member 31, can be visually recognized via the slit 13. To overcome this, a reflection reduction sheet such as a porous resin material, which reduces the reflection of light on inner walls of the support member 31, may be attached, or coating materials may be coated thereon. In addition, the attachment may be performed only at a position at which the stray light resulting from the specular reflection occurs among inner walls of the support member 31.

In this embodiment, although the shape of the display 21 is described as an arc shape, the shape may not necessarily be a strict arc. Thus, the arc may be sides of a polygon similar to an arc. In addition, in the curvature of the arc or the curvature of the sides of the polygon similar to the arc, a total of values may not be constant.

In this embodiment, although stereoscopic 3D image is displayed from all directions, it is also possible to display 2D image from all directions. Alternatively, the all of the directions may be divided into a plurality of numbers, and information (time, news, an advertisement, a guide, or the like) having the different divided numbers may be displayed at the same time.

The present disclosure may be generally applied to a flexible display other than an LED array.

It should be understood by those skilled in the art that various modifications, combinations, sub-combinations and alterations may occur depending on design requirements and other factors insofar as they are within the scope of the appended claims or the equivalents thereof.

The present disclosure contains subject matter related to that disclosed in Japanese Priority Patent Application JP 2011-147909 filed in the Japan Patent Office on Jul. 4, 2011, the entire content of which is hereby incorporated by reference.

What is claimed is:

1. A display device comprising:
a housing whose side surface has one or more slits; and
a display that is mounted in the housing and has a substantially arc shape,
wherein an image displayed on the display is visually recognized beyond the slit when the housing rotates, and
a curvature of the display having the substantially arc shape is formed so that stray light resulting from a specular reflection does not occur.

2. The display device according to claim 1, wherein, when a spot at which light emitted from an arbitrary spot s on the display is subjected to specular reflection is defined as a, a center of the arc of the display is defined as b, a center of the slit is defined as c, an angle formed by spots s, a, and b is defined as α, and an angle formed by spots b, a and c is β, α>β is always satisfied.

3. The display device according to claim 2, further comprising:
a support member that supports the display,
wherein a reflection reduction sheet is attached to the support member to reduce reflection of light, or a coating material is coated thereon.

4. The display device according to claim 3, wherein the housing has a cylindrical shape.

5. The display device according to claim 4, wherein the display having the substantially arc shape is configured to be same in number as the slits.
